(19) United States
(12) Patent Application Publication
(10) Pub. No.: US 2025/0065932 A1
(43) Pub. Date: Feb. 27, 2025

(54) Flowerpot Moving Device

(71) Applicants: Thomas Strickland, Tampa, FL (US); Albert Blount, Tampa, FL (US); Cynthia Blount, Tampa, FL (US); Linda Strickland, Tampa, FL (US)

(72) Inventors: Thomas Strickland, Tampa, FL (US); Albert Blount, Tampa, FL (US); Cynthia Blount, Tampa, FL (US); Linda Strickland, Tampa, FL (US)

(21) Appl. No.: 18/502,837

(22) Filed: Nov. 6, 2023

Related U.S. Application Data
(60) Provisional application No. 63/578,468, filed on Aug. 24, 2023.

(51) Int. Cl. B62B 1/16; A01G 9/02; B62B 1/00; B62B 5/06

(52) U.S. Cl. CPC B62B 1/16; A01G 9/02; B62B 1/008; B62B 5/067; B62B 5/0096; B62B 2202/70

(57) ABSTRACT

A flowerpot moving device that allows for the moving of large flowerpots quickly and with ease. The flowerpot moving device comprises a body component that is configured as the flowerpot with a base portion and an upper perimeter portion. The body component comprises a set of wheels on one side of the base portion and a rubber stabilizing bar on the opposite side of the base portion. Further, the body component comprises a telescoping handle on the upper perimeter portion, that extends out and locks into place when the user is ready to move the flowerpot. Once the flowerpot has been moved, a button on the handle is pushed, which will retract the handle back down. Thus, users can transport their flowerpots to and from any location with minimal physical effort required.

### CROSS-REFERENCE TO RELATED APPLICATION

The present application claims priority to, and the benefit of, U.S. Provisional Application No. 63/578,468, which was filed on Aug. 24, 2023, and is incorporated herein by reference in its entirety.

### FIELD OF THE INVENTION

The present invention relates generally to the field of flowerpot moving devices. More specifically, the present invention relates to a flowerpot that has a built-in hand truck which will provide ease and convenience when moving large flowerpots. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in flowerpot moving devices. Generally, people who enjoy planting flowers and displaying them in different areas may have trouble moving flowerpots filled with dirt and flowers. These flowerpots are heavy and require significant lifting and physical strength to move. Further, trying to quickly move the flowerpot during a sudden storm or other in clement weather event can be difficult and frustrating.

Flowerpots for the planting of herbaceous materials are well known. Flowerpots may vary in size from the smallest pots having a volume of only a few cubic inches to large pots of several cubic feet and capable of supporting a variety of different and decorative flowers and for small or medium-sized shrubs or trees. It is well known that flowerpots may be made or formed from any suitable material, such as fired terra cotta, ceramics, metals, plastics, or other acceptable materials. Suitable plastic materials can be readily injection molded or blow molded to form various designs of flowerpots. Flowerpots are typically permanent containers for decorative plants in homes, yards, or commercial locations. Quite often, a homeowner or business owner desires to relocate the flowerpots containing the decorative plants. Such transport is readily accomplished by most persons when a flowerpot is loaded with herbaceous material. However, large flowerpots when loaded may weigh as much as 50 to 100 pounds or more and are not readily carried or transported to a new or different location. Even lighter-loaded flowerpots may not be easily transported by older or disabled people.

Accordingly, there is a demand for an improved flowerpot moving device that has a built-in hand truck for case and convenience when moving, large flowerpots. More particularly, there is a demand for a flowerpot with a telescoping handle and wheels for moving the flowerpot even when filled with dirt and flowers.

Therefore, there exists a long-felt need in the art for a flowerpot moving device that provides users with a flowerpot that has a built-in hand truck which will provide case and convenience when moving large flowerpots. There is also a long-felt need in the art for a flowerpot moving device that includes a telescoping handle on the upper perimeter that can be used to grab and quickly move the flowerpot. Further, there is a long-felt need in the art for a flowerpot moving device that allows the flowerpot device to move via two durable solid rubber or solid plastic wheels on the base. Moreover, there is a long-felt need in the art for a device that features a rubber stabilizer on the opposite side of the rubber wheels, ensuring the device remains in place when stored on a patio, sidewalk, a garden, and any other outdoor location. Further, there is a long-felt need in the art for a flowerpot moving device that offers a way for anyone, regardless of age or physical strength and dexterity, to quickly move a flowerpot at any time. Finally, there is a long-felt need in the art for a flowerpot moving device that is available in different sizes and configurations.

The subject matter disclosed and claimed herein, in one embodiment thereof, comprises a flowerpot moving device. The device allows for the moving of large flowerpots quickly and with case. The flowerpot moving device comprises a body component that is configured as the flowerpot with a base portion and an upper perimeter portion. The body component comprises a set of wheels on one side of the base portion and a rubber stabilizing bar on the opposite side of the base portion. Further, the body component comprises a telescoping handle on the upper perimeter portion, that extends out and locks into place when the user is ready to move the flowerpot. Once the flowerpot has been moved, a button on the handle is pushed, which will retract the handle back down. Thus, users can transport their flowerpots to and from any location with minimal physical effort required. Additionally, the device is available in multiple sizes and configurations, as needed.

In this manner, the flowerpot moving device of the present invention accomplishes all of the foregoing objectives and provides users with a device that provides a built-in hand truck to move flowerpots. The device is a flowerpot with a set of wheels and a retractable handle attached. The device is available in multiple sizes and configurations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flowerpot moving device. The device allows for the moving of large flowerpots quickly and with case. The flowerpot moving device comprises a body component that is shaped as a flowerpot. The body component comprises a set of wheels on one side and a rubber stabilizing bar on the opposite side. Further, the body component comprises a telescoping handle on the upper perimeter portion, that extends out and locks into place when the user is ready to move the flowerpot device. Once the flowerpot device has been moved, a button on the handle is pushed, which will retract the handle back down. Thus, users can transport their flowerpots to and from any location with minimal physical effort required.

In one embodiment, the flowerpot moving device in accordance with the present invention, preferably comprises a flowerpot-shaped body component having an upper opening, generally an upright arcuate side or wall forming a somewhat cylindrically-shaped container, wherein the wall has an interior or inner surface and an exterior or outer surface, and a bottom for holding the planting medium and one or more living or artificial plants. Preferably, the side or wall tapers inward from a rim or upper perimeter surrounding the opening to the bottom. The wall can be of suitable shape and size to form a cylindrical pot-shaped body component or the pot-shaped body component can be comprised of independent walls which form, for example, a pot-shaped cubic container having four vertical walls and a bottom. Thus, the shape, size, and configuration of the flowerpot-shaped body component may, of course, be of any suitable shape, size, or configuration.

In one embodiment, the rim or upper perimeter of the body component is formed in an outward roll to provide structural rigidity to the flowerpot-shaped body component at the upper opening, and also to provide a means for lifting the pot-shaped body component when empty, or tipping pot-shaped body component when full. Further, the bottom preferably includes an elevated portion having drain holes therein to promote water drainage through such plurality of drain holes.

In one embodiment, the flowerpot-shaped body component may be made or formed out of any suitable material, including, but not limited to, fired terra cotta, ceramics, metals or plastics, etc., which plastics can be readily injection molded or blow molded. Similarly, extensible and retractable telescoping handle and its parts or mechanisms for operation can be made of any suitable material, such as, for example, metal, plastic, wood, or a combination of such materials, such as metal and plastic.

In one embodiment, the flowerpot-shaped body component comprises a set of wheels secured to the bottom or base of the body component via an axle. Specifically, first and second wheels are mounted in a known fashion on the extending ends of the axle and secured thereupon by fastener means. The wheels can be any suitable wheels and are secured to one end of the base via any suitable securing means as is known in the art, such as gluing, bolts, pins, welding, screws, etc. Any suitable number of wheels can be utilized as is known in the art, but typically there are two wheels disposed on an end of the base, which allows the device to roll. In one embodiment, the set of wheels may rotate, swivel, and pivot, based on a user's preference and/or commands. Further, any suitable wheels can be utilized as is known in the art, such as castors, rollers, swivel wheels, etc. In one embodiment, the set of wheels are rugged, all-terrain wheels which help the device travel around the yard and over rough terrain during use. Additionally, the wheels can be durable solid rubber, solid plastic wheels, or any other suitable material as is known in the art.

In one embodiment, it is preferable that the wheel axle be positioned with respect to the bottom of the pot-shaped body component, such that a load is not imposed on the wheels when the device is not being moved, to prevent the wheels from developing flat spots, thus the distance from the axle axis to the bottom of the body component is preferably slightly greater than the radius of the wheels. However, this is not a requirement, and all configurations of a wheel assembly are intended to be fully comprehended for use with the present invention.

All variations on structures of the flowerpot moving device discussed immediately hereinabove feature axles and wheels that are permanently mounted to the flowerpot-shaped body component. However, a flowerpot moving device wherein the axles and wheels may be installed for moving the device and may be removed following the move are fully contemplated, as well.

In one embodiment, the flowerpot-shaped body component comprises a rubber stabilizing bar secured to the bottom or base of the body component, on an opposing side from the set of wheels. The rubber stabilizing bar is secured to the opposing side of the base via any suitable securing means as is known in the art, such as gluing, bolts, pins, welding, screws, etc. Further, the rubber stabilizing bar can be any suitable shape and size as is known in the art, as long as the stabilizing bar fits underneath the body component and does not protrude out from the bottom of the body component. Further, the stabilizing bar needs to be the same height as the set of wheels, ensuring that the device remains in place when stored on a patio, sidewalk, in a garden, and any other suitable outdoor location.

In one embodiment, the flowerpot-shaped body component comprises a telescoping handle secured to the exterior or outer surface of the wall or located at or near the interior or inner wall, so that the handle cannot be seen by a viewer when it is extended or retracted into the flowerpot-shaped body component of the present invention. The telescoping or retractable handle is pivotable between a retracted, non-operative position to an extended, operative position.

In one embodiment, the handle may be of any convenient suitable shape, but preferably is a double rod-shaped structure, with the double rods being in a parallel configuration. Specifically, the handle is shaped and sized to resemble a typical luggage handle with two parallel vertical rods connected at their ends, in a spaced apart configuration by a horizontal rod, which acts as a handhold. However, the handle can be any suitable shape and size as is known in the art, such as a single rod with a horizontal rod connected in a T-shape for use as a handhold, as long as the handle is telescoping and can extend and retract as needed.

Specifically, the elongated rods of the handle can be telescoping, such that the elongated vertical rods can be extended and/or retracted, as needed. Further, the telescoping handle comprises at least one telescoping segment that allows the total length of the handle to be extended or retracted. Each telescoping segment is hollow and has a slip lock for locking the segment at a specific length. Further, the slip lock is released by means of pressing or turning the slip lock. Then at least one telescoping segment allows the handle to have a length from approximately two feet to four feet fully extended, allowing a user to set the handle at a desired length. Thus, the handle is approximately two feet in length but can be adjusted to a length of approximately four feet, if needed. Any type of telescoping locks, such as a clutch lock, cam lock, spring button, snap lock, set knob, slip lock, or any other suitable lock as is known in the art, can be used for securing a desired length of the telescoping segments and for securing the telescoping segments to each other, during extension and retraction of the telescoping segments of the handle. Further, the horizontal rod of the handle comprises a button, which when depressed releases the locked handle i.e., the slip locks of the telescoping segments) and allows the handle to retract to its original position.

In one embodiment, the handle can be removed instead of retracted. In this embodiment, the body component comprises a threaded socket and the handle can have a threaded end, which is then threaded into the socket to secure the handle in an upright position. After use, the handle can be unscrewed, removed, and stored away from the device.

In one embodiment, the flowerpot moving device is available in many different sizes, shapes, and configurations to accommodate all of a user's needs and/or wants.

In use, a user pulls on the handle in an upward position, to extend and lock the handle in place. The handle is then pushed downward by a user, such that the flowerpot moving device is pivoted at an angle, and such that the set of wheels are engaged with the ground surface upon which the flowerpot moving device rests. This movement raises the flowerpot-shaped body component from contact with the ground surface. In the resulting pivoted position, the flowerpot moving device is ready for relocation by being rolled along the ground surface on the set of wheels. When relocation is complete, the pivoting process is reversed and the button on the handle is pressed, causing the handle to retract.

In yet another embodiment, the flowerpot moving device comprises a plurality of indicia.

In yet another embodiment, a method of moving a flowerpot is disclosed. The method includes the steps of providing a flowerpot moving device comprising a body component with a base portion and an upper perimeter portion, such that a set of wheels are secured to the base and a rubber stabilizing bar on the opposite side, and a telescoping handle secured to the upper perimeter portion. The method also comprises filling the flowerpot body component with dirt and flowers, as desired. Further, the method comprises extending the handle and tilting the body component on its wheels. The method also comprises transporting the flowerpot body component via the wheels, by pulling the handle. Finally, the method comprises retracting the handle once the flowerpot has been moved to a desired location.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the flowerpot moving device of the present invention showing the device in different sizes and configurations in accordance with the disclosed architecture;

FIGS. 2A-B illustrate a perspective view of one embodiment of the flowerpot moving device of the present invention showing the handle and the base in accordance with the disclosed architecture;

FIGS. 3A-B illustrate a perspective view of one embodiment of the flowerpot moving device of the present invention showing the handle extended and retracted in accordance with the disclosed architecture;

FIG. 4 illustrates a perspective view of one embodiment of the flowerpot moving device of the present invention showing the device in use in accordance with the disclosed architecture;

FIGS. 5A-B illustrate a perspective view of one embodiment of the flowerpot moving device of the present invention with different-sized flowerpots in accordance with the disclosed architecture; and

FIG. 6 illustrates a flowchart showing the method of moving a flowerpot in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a flowerpot moving device that provides users with a flowerpot that has a built-in hand truck which will provide case and convenience when moving large flowerpots. There is also a long-felt need in the art for a flowerpot moving device that includes a telescoping handle on the upper perimeter that can be used to grab and quickly move the flowerpot. Further, there is a long-felt need in the art for a flowerpot moving device that allows the flowerpot device to move via two durable solid rubber or solid plastic wheels on the base. Moreover, there is a long-felt need in the art for a device that features a rubber stabilizer on the opposite side of the rubber wheels, ensuring the device remains in place when stored on a patio, sidewalk, a garden, and any other outdoor location. Further, there is a long-felt need in the art for a flowerpot moving device that offers a way for anyone, regardless of age or physical strength and dexterity, to quickly move a flowerpot at any time. Finally, there is a long-felt need in the art for a flowerpot moving device that is available in different sizes and configurations.

The present invention, in one exemplary embodiment, is a novel flowerpot moving device. The device allows for the moving of large flowerpots quickly and with ease. The flowerpot moving device comprises a body component that is configured as the flowerpot with a base portion and an upper perimeter portion. The body component comprises a set of wheels on one side of the base portion and a rubber stabilizing bar on the opposite side of the base portion. Further, the body component comprises a telescoping handle on the upper perimeter portion, that extends out and locks into place when the user is ready to move the flowerpot. Once the flowerpot has been moved, a button on the handle is pushed, which will retract the handle back down. The present invention also includes a novel method of moving a flowerpot. The method includes the steps of providing a flowerpot moving device comprising a body component with a base portion and an upper perimeter portion, such that a set of wheels are secured to the base and a rubber stabilizing bar on the opposite side, and a telescoping handle secured to the upper perimeter portion. The method also comprises filling the flowerpot body component with dirt and flowers, as desired. Further, the method comprises extending the handle and tilting the body component on its wheels. The method also comprises transporting the flowerpot body component via the wheels, by pulling the handle. Finally, the method comprises retracting the handle once the flowerpot has been moved to a desired location.

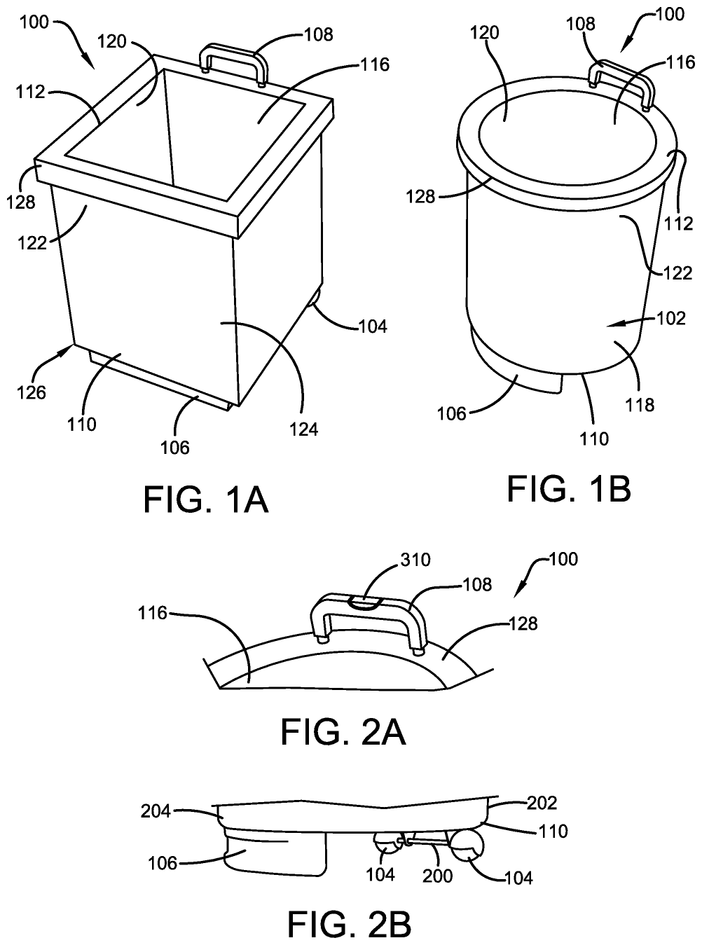

Referring initially to the drawings, FIGS. 1A-B illustrates a perspective view of one embodiment of the flowerpot moving device 100 of the present invention. In the present embodiment, the flowerpot moving device 100 is an improved flowerpot moving device 100 that allows a user 114 to move large flowerpots quickly and with case. Specifically, the flowerpot moving device 100 comprises a body component 102 that is shaped as the flowerpot. The body component 102 comprises a set of wheels 104 and a rubber stabilizing bar 106 on the bottom 110 and a telescoping handle 108 on the upper perimeter portion 112. The handle 108 extends out and locks into place when the user 114 is ready to move the flowerpot device 100. Once the flowerpot device 100 has been moved, the handle 108 will retract back down for storage. Thus, users 114 can transport their flowerpots to and from any location with minimal physical effort required.

Generally, the flowerpot moving device 100 in accordance with the present invention, preferably comprises a flowerpot-shaped body component 102 having an upper opening 116. generally an upright arcuate side or wall 118 forming a somewhat cylindrically-shaped container, wherein the wall 118 has an interior or inner surface 120 and an exterior or outer surface 122, and a bottom 110 for holding the planting medium and one or more living or artificial plants. Preferably, the side or wall 118 tapers inward from a rim or upper perimeter 112 surrounding the opening 116 to the bottom 110. The wall 118 can be of suitable shape and size to form a cylindrical pot-shaped body component 102 or the pot-shaped body component 102 can be comprised of independent walls 124 which form, for example, a pot-shaped cubic container 126 having four vertical walls 124 and a bottom 110. Thus, the shape, size, and configuration of the flowerpot-shaped body component 102 may, of course, be of any suitable shape, size, or configuration.

Further, the rim or upper perimeter 112 of the body component 102 is formed in an outward roll 128 to provide structural rigidity to the flowerpot-shaped body component 102 at upper opening 116, and also to provide means for lifting pot-shaped body component 102 when empty, or tipping pot-shaped body component 102 when full. Further, the bottom 110 preferably includes an elevated portion having drain holes (not shown) therein to promote water drainage through such plurality of drain holes.

Typically, the flowerpot-shaped body component 102 may be made or formed out of any suitable material, including, but not limited to, fired terra cotta, ceramics, metals or plastics, etc., which plastics can be readily injection molded or blow molded. Similarly, extensible and retractable telescoping handle 108 and its parts or mechanism for operation can be made of any suitable material, such as, for example, metal, plastic, wood, or a combination of such materials, such as metal and plastic.

As shown in FIGS. 2A-B, the flowerpot-shaped body component 102 comprises a set of wheels 104 secured to the bottom 110 or base of the body component 102 via an axle 200. Specifically, first and second wheels 104 are mounted in known fashion on the extending ends of the axle 200 and secured thereupon by fastener means. The wheels 104 can be any suitable wheels and are secured to one end 202 of the bottom 110 via any suitable securing means as is known in the art, such as gluing, bolts, pins, welding, screws, etc. Any suitable number of wheels 104 can be utilized as is known in the art, but typically there are two wheels 104 disposed on an end 202 of the base 200, which allows the device 100 to roll. In one embodiment, the set of wheels 104 may rotate, swivel, and pivot, based on a user's preference and/or commands. Further, any suitable wheels 104 can be utilized as is known in the art, such as castors, rollers, swivel wheels, etc. In one embodiment, the set of wheels 104 are rugged, all-terrain wheels which help the device 100 travel around the yard and over rough terrain during use. Additionally, the wheels 104 can be durable solid rubber or solid plastic wheels, or any other suitable material as is known in the art.

In one embodiment, it is preferable that the wheel axle 200 be positioned with respect to the bottom 110 of the pot-shaped body component 102, such that a load is not imposed on the wheels 104 when the device 100 is not being moved, to prevent the wheels 104 from developing flat spots, thus the distance from the axle 200 axis to the bottom 110 of the body component 102 is preferably slightly greater than the radius of the wheels 104. However, this is not a requirement, and all configurations of a wheel assembly are intended to be fully comprehended for use with the present invention.

Furthermore, all variations on structures of the flowerpot moving device 100 discussed immediately hereinabove feature axles 200 and wheels 104 that are permanently mounted to the flowerpot-shaped body component 102. However, a flowerpot moving device 100 wherein the axles 200 and wheels 104 may be installed for moving the device 100 and may be removed following the move are fully contemplated, as well.

Additionally, the flowerpot-shaped body component 102 comprises a rubber stabilizing bar 106 secured to the bottom 110 or base of the body component 102, on an opposing side 204 from the set of wheels 104. The rubber stabilizing bar 106 is secured to the opposing side 204 of the base 110 via any suitable securing means as is known in the art, such as gluing, bolts, pins, welding, screws, etc. Further, the rubber stabilizing bar 106 can be any suitable shape and size as is known in the art, as long as the stabilizing bar 106 fits underneath the body component 102 and does not protrude out from the bottom 110 of the body component 102. Further, the stabilizing bar 106 needs to be the same height as the set of wheels 104, ensuring that the device 100 remains in place, when stored on a patio, sidewalk, in a garden, and any other suitable outdoor location.

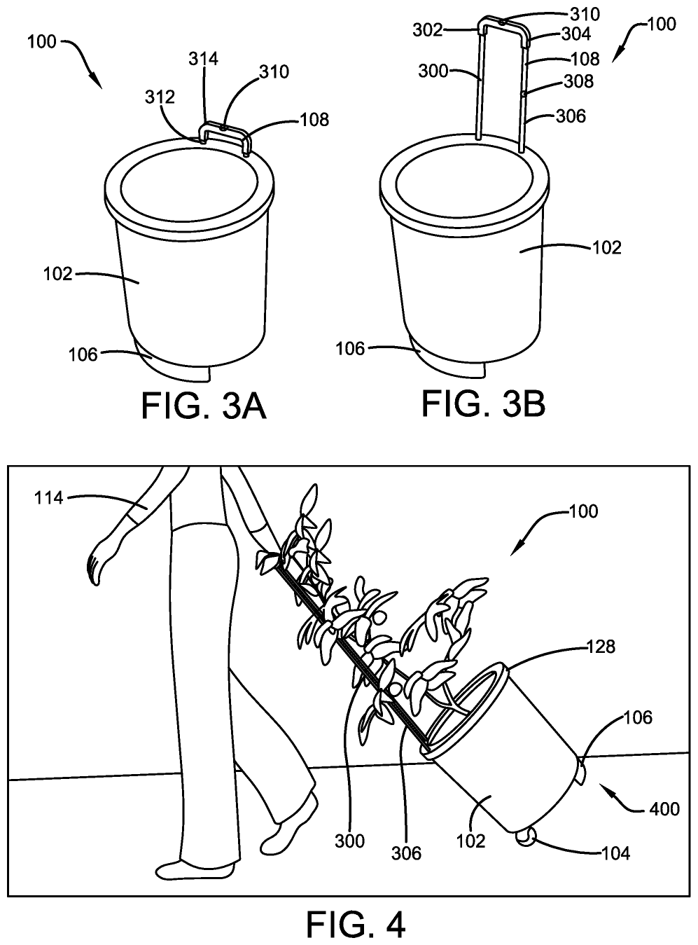

As shown in FIG. 2A and FIGS. 3A-B, the flowerpot-shaped body component 102 comprises a telescoping handle 108 secured to the exterior or outer surface 122 of the wall 118 or located at or near the interior or inner wall 120, so that the handle 108 cannot be seen by a viewer when it is extended or retracted into the flowerpot-shaped body component 102 of the present invention. The telescoping or retractable handle 108 is pivotable between a retracted, non-operative position to an extended, operative position.

Furthermore, the handle 108 may be of any convenient suitable shape, but preferably is a double rod-shaped structure, with the double rods 300 being in a parallel configuration. Specifically, the handle 108 is shaped and sized to resemble a typical luggage handle with two parallel vertical rods 300 connected at their ends 302, in a spaced apart configuration by a horizontal rod 304, which acts as a handhold. However, the handle 108 can be any suitable shape and size as is known in the art, such as a single rod 300 with a horizontal rod 304 connected in a T-shape for use as a handhold, as long as the handle 108 is telescoping and can extend and retract as needed.

Specifically, the elongated rods 300 of the handle 108 can be telescoping, such that the elongated vertical rods 300 can be extended and/or retracted, as needed. Further, the telescoping handle 108 comprises at least one telescoping segment 306 that allows the total length of the handle 108 to be extended or retracted. Each telescoping segment 306 is hollow and has a slip lock 308 for locking the segment 306 at a specific length. Further, the slip lock 308 is released by means of pressing or turning the slip lock 308. Then at least one telescoping segment 306 allows the handle 108 to have a length from approximately two feet to four feet fully extended, allowing a user 114 to set the handle 108 at a desired length. Thus, the handle 108 is approximately two feet in length but can be adjusted to a length of approximately four feet, if needed. Any type of telescoping locks, such as a clutch lock, cam lock, spring button, snap lock, set knob, slip lock, or any other suitable lock as is known in the art, can be used for securing a desired length of the telescoping segments 306 and for securing the telescoping segments 306 to each other, during extension and retraction of the telescoping segments 306 of the handle 108. Further, the horizontal rod 304 of the handle 108 comprises a button 310, which when depressed releases the locked handle 108 (i.e., the slip locks 308 of the telescoping segments 306) and allows the handle 108 to retract to its original position.

In one embodiment, the handle 108 can be removed instead of retracted. In this embodiment, the body component 102 comprises a threaded socket 312, and the handle 108 can have a threaded end 314, which is then threaded into the socket 312 to secure the handle 108 in an upright position. After use, the handle 108 can be unscrewed, removed, and stored away from the device 100.

As shown in FIG. 4, in use, a user 114 pulls on the handle 108 to extend it in an upward position, and locks the handle 108 in place. The handle 108 is then pushed downward by a user 114, such that the flowerpot moving device 100 is pivoted at an angle, and such that the set of wheels 104 are engaged with the ground surface 400 upon which the flowerpot moving device 100 rests. This movement raises the flowerpot-shaped body component 102 from contact with the ground surface 400. In the resulting pivoted position, the flowerpot moving device 100 is ready for relocation by being rolled along the ground surface 400 on the set of wheels 104. When relocation is complete, the pivoting process is reversed and the button 310 on the handle 108 is pressed, causing the handle 108 to retract.

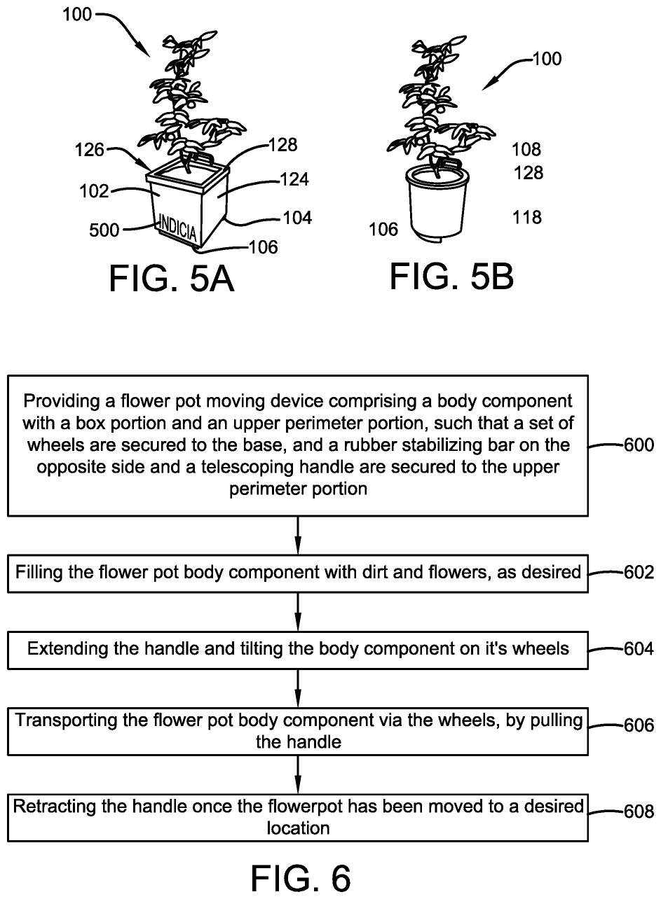

As shown in FIGS. 5A-B, the flowerpot moving device 100 is available in many different sizes, shapes, and configurations to accommodate all of a user's needs and/or wants. Thus, the flowerpot moving device 100 can be configured as a cylinder, a cube, a rectangle, etc., or any other suitable shape as is known in the art. Further, the flowerpot moving device 100 can comprise any suitable color, design, pattern, etc., depending on the needs and/or want of a user 114.

In yet another embodiment, the flowerpot moving device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be flowerpot, transport, or brand related.

FIG. 6 illustrates a flowchart of the method of moving a flowerpot. The method includes the steps of at 600, providing a flowerpot moving device comprising a body component with a base portion and an upper perimeter portion, such that a set of wheels are secured to the base and a rubber stabilizing bar on the opposite side, and a telescoping handle secured to the upper perimeter portion. The method also comprises at 602, filling the flowerpot body component with dirt and flowers, as desired. Further, the method comprises at 604, extending the handle and tilting the body component on its wheels. The method also comprises at 606, transporting the flowerpot body component via the wheels, by pulling the handle. Finally, the method comprises at 608, retracting the handle once the flowerpot has been moved to a desired location.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “flowerpot moving device”, “flowerpot device”, “moving device”, and “device” are interchangeable and refer to the flowerpot moving device 100 of the present invention.

Notwithstanding the foregoing, the flowerpot moving device 100 of the present invention can be of any suitable size and configuration as is known in the art without affecting the overall concept of the invention, provided that it accomplishes the above-stated objectives. One of ordinary skill in the art will appreciate that the flowerpot moving device 100 as shown in FIGS. 1-6 is for illustrative purposes only, and that many other sizes and shapes of the flowerpot moving device 100 are well within the scope of the present disclosure. Although the dimensions of the flowerpot moving device 100 are important design parameters for user convenience, the flowerpot moving device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flowerpot moving device that allows a user to move large flowerpots quickly and with ease, the flowerpot moving device comprising:
a body component shaped as a flowerpot;
a set of wheels; and
a handle;
wherein the body component comprises a set of wheels on the bottom of the body component;
wherein the handle is secured to an upper perimeter of the body component; and
further wherein a user pulls the handle and moves the body component via the set of wheels, allowing the user to transport the body component to and from any location with minimal physical effort required.

2. The flowerpot moving device of claim 1, wherein the body component comprises an upper opening, an upright arcuate wall forming a somewhat cylindrically-shaped container, wherein the upright arcuate wall has an interior surface and an exterior surface, and a bottom for holding planting medium and one or more living or artificial plants.

3. The flowerpot moving device of claim 2, wherein the wall tapers inward from the upper perimeter surrounding the upper opening to the bottom.

4. The flowerpot moving device of claim 2, wherein the walls form a cubic container having four vertical walls and a bottom.

5. The flowerpot moving device of claim 2, wherein the upper perimeter of the body component is formed in an outward roll to provide structural rigidity to the body component at the upper opening.

6. The flowerpot moving device of claim 5, wherein the set of wheels are mounted to either end of an axle and secured to the bottom of the body component at a first end.

7. The flowerpot moving device of claim 6, wherein the body component comprises a stabilizing bar secured to the bottom of the body component, on an opposing side from the set of wheels.

8. The flowerpot moving device of claim 7, wherein the stabilizing bar fits underneath the body component and does not protrude out from the bottom and is same height as the set of wheels, ensuring that the body component remains in place.

9. The flowerpot moving device of claim 8, wherein the handle comprises two parallel vertical rods connected at their ends, in a spaced apart configuration by a horizontal rod, which acts as a handhold.

10. The flowerpot moving device of claim 9, wherein the handle comprises at least one telescoping segment that allows a total length of the handle to be extended or retracted.

11. The flowerpot moving device of claim 10, wherein the at least one telescoping segment is hollow and has a slip lock for locking the at least one telescoping segments at a specific length.

12. The flowerpot moving device of claim 11, wherein the at least one telescoping segments allow the handle to have a length from approximately two feet to four feet fully extended, allowing a user to set the handle at a desired length.

13. The flowerpot moving device of claim 12, wherein the horizontal rod of the handle comprises a button, which when depressed releases the handle and allows the handle to retract to its original position.

14. A flowerpot moving device that allows a user to move large flowerpots quickly and with ease, the flowerpot moving device comprising:
a body component shaped as a flowerpot, which comprises an upper opening, an upright arcuate wall forming a somewhat cylindrically-shaped container, wherein the upright arcuate wall has an interior surface and an exterior surface, and a bottom for holding planting medium and one or more living or artificial plants, and wherein the wall tapers inward from the upper perimeter surrounding the upper opening to the bottom;
a set of wheels mounted to either end of an axle and secured to the bottom of the body component at a first end;
a stabilizing bar secured to the bottom of the body component, on an opposing side from the set of wheels; and
a handle comprising two parallel vertical rods connected at their ends, in a spaced apart configuration by a horizontal rod, which acts as a handhold;
wherein the upper perimeter of the body component is formed in an outward roll to provide structural rigidity to the body component at the upper opening;
wherein the stabilizing bar fits underneath the body component and does not protrude out from the bottom and is same height as the set of wheels, ensuring that the body component remains in place;
wherein the handle is secured to an upper perimeter of the body component;
wherein the handle comprises at least one telescoping segment that allows a total length of the handle to be extended or retracted;
wherein the at least one telescoping segment is hollow and has a slip lock for locking the at least one telescoping segments at a specific length;
wherein the horizontal rod of the handle comprises a button, which when depressed releases the handle and allows the handle to retract to its original position; and
further wherein a user pulls the handle and moves the body component via the set of wheels, allowing the user to transport the body component to and from any location with minimal physical effort required.

15. The flowerpot moving device of claim 14 further comprising a plurality of indicia.

16. The flowerpot moving device of claim 14, wherein the at least one telescoping segments allow the handle to have a length from approximately two feet to four feet fully extended, allowing a user to set the handle at a desired length.

17. The flowerpot moving device of claim 14, wherein the flowerpot moving device is available in many different sizes, shapes, and configurations to accommodate all of a user's needs and wants.

18. The flowerpot moving device of claim 14, wherein a user pulls on the handle to extend it in an upward position and lock the handle in place; and pushes downward on it, such that the set of wheels are engaged with a ground surface upon which the flowerpot moving device rests.

19. The flowerpot moving device of claim 18, wherein in pivoted position, the flowerpot moving device is rolled along the ground surface on the set of wheels; and then the button on the handle is pressed, causing the handle to retract.

20. A method of moving a flowerpot, the method comprising the following steps:
providing a flowerpot moving device comprising a body component with a base portion and an upper perimeter portion, such that a set of wheels are secured to the base and a rubber stabilizing bar on the opposite side, and a telescoping handle secured to the upper perimeter portion;
filling the flowerpot body component with dirt and flowers, as desired;
extending the handle and tilting the body component on its wheels;
transporting the flowerpot body component via the wheels, by pulling the handle; and
retracting the handle once the flowerpot has been moved to a desired location.
